(19) United States
(12) Patent Application Publication
(10) Pub. No.: US 2013/0052328 A1
(43) Pub. Date: Feb. 28, 2013

(54) METHOD FOR REACTIVELY CRUSHING JATROPHA SEEDS

(71) Applicants: Jean-Luc Dubois, Millery (FR); Julien Magne, Roches-Primaries-Andille (FR); Antoine Piccirilli, Poitiers (FR)

(72) Inventors: Jean-Luc Dubois, Millery (FR); Julien Magne, Roches-Primaries-Andille (FR); Antoine Piccirilli, Poitiers (FR)

(21) Appl. No.: 13/575,415

(22) PCT Filed: Jan. 26, 2011
(86) PCT No.: PCT/FR2011/050155

§ 371 Date: Nov. 9, 2012

(30) Foreign Application Priority Data
Jan. 26, 2010 (FR) 1050486

(51) Int. Cl. C11B 1/10; A23K 1/14

(52) U.S. Cl. 426/630; 554/13; 426/629

(57) ABSTRACT

The present invention relates to a method for reactively crushing jatropha seeds, said method making it possible, starting with specifically conditioned jatropha seeds in the presence of light alcohol and a basic catalyst, to carry out, in a single step, the crushing as well as the reaction for transesterifying the triglycerides present in the jatropha oil, thus causing an oil cake, glycerol, and fatty acid esters to be simultaneously produced. The method for processing the jatropha seeds, according to the invention, makes it possible to inactivate, in a simple, low-cost manner, the phorbol esters in addition to the curcine, thus enabling humans to handle the seeds without risk and moreover use the castor oil cake in animal feed. Characteristically, the seeds are conditioned by a series of operations that include a step of pressing the seeds and a step of drying same.

The present invention relates to a method for the reactive grinding of Jatropha seeds which, starting from specifically processed Jatropha seeds in the presence of a light alcohol and a basic catalyst, makes it possible to carry out the grinding and the reaction for transesterification of the triglycerides present in the Jatropha oil in a single step, simultaneously producing an oil cake, glycerol and fatty acid esters. Said esters are intended mainly for the production of biodiesel. Furthermore, the method according to the invention makes it possible to obtain a completely detoxified oil cake. The oil cakes obtained by the method for treating Jatropha (in particular Jatropha curcas L.) seeds according to the invention retain a nutritional value and can be directly used in animal feed, without constituting a risk to the health of the individuals who handle them.

It is known practice to prepare fatty acid esters from seeds of oleaginous plants in two steps, namely a step of extraction of oil in the presence of solvent and a step of transesterification of this oil in the presence of alcohol and of catalyst, producing an ester phase and a glycerol phase.

The Jatropha genus comprises several species known for the irritant properties of their seeds in humans and animals. They are tropical plants grown in Latin America, in Asia and in Africa and used mainly as hedging. Their potential nutritional and technical applications, in particular in controlling soil erosion and preparing biodiesel, are at present limited owing to their toxicity.

Jatropha seeds are rich in oil and in proteins, but they are highly toxic and incompatible with human or animal consumption. The toxic and anti-nutritional compounds of Jatropha include curcin (a lectin), flavonoids, trypsin inhibitors, saponins, phytates and phorbol esters. The lectin and the activity of the trypsin inhibitors can be removed by heat treatment. The high concentrations of phorbol esters, which are thermally stable, remain the principal source of toxicity of the oil extracted from the Jatropha seeds and the oil cakes. Indeed, this family of compounds is known for its harmful biological effects in humans and animals, in particular in inflammation and promotion of tumors. The phorbol esters do not induce a tumor by themselves, but facilitate the growth of tumors after exposure to doses considered to be noncarcinogenic of a carcinogenic compound.

The phorbol ester content varies among the various varieties of Jatropha, as shown by the study by Makkar H. P. S et al. J. Agric. Food Chem. 45:8, 1997, 3152-3157. The data presented in table 4 show that these compounds were detected in most of the varieties tested. There is one variety in which the phorbol esters are virtually absent, the Jatropha grown in Mexico, while the other varieties are more or less rich in these compounds (in particular the Jatropha originating from Kenya or Nicaragua).

Jatropha oil cake can be used in animal feed only if the removal of toxic and anti-nutritional compounds can be guaranteed. The toxic effects of Jatropha seeds on animals appear to be linked to the dosage, as shown in the publication by S. E. I. Adam, Toxicol. 2: 67-76, 1974. The data presented in table 1 of the publication Vet. Pathol. 16: 476-482, 1979 show that animals fed with Jatropha seeds die after several days, probably because of a cumulative effect of the toxic compounds.

The publication by W. Haas and M. Mittelbach, Ind. Crops Prod. 12 (2000), 111-118 describes a method for assaying phorbol esters in Jatropha oil and also various treatments of the oil. It is shown that the conventional oil degumming and deodorization treatments have little influence on the concentration of these compounds, whereas deacidification and bleaching make it possible to reduce the phorbol ester content to 55%, which remains insufficient.

Various Jatropha detoxification methods have been tested.

Heating the Jatropha seeds at 160° C. for 30 minutes does not make it possible to remove the phorbol esters (Aregheore E. M. et al., S. Pac. J. Nat. Sci. 21: 50-56, 2003).

The injection of steam into the protein extracts obtained from defatted oil cakes for 10 min at approximately 92° C. makes it possible to remove the phorbol esters (Devappa R. K. and Swamylingappa B., J. Sci. Food Agric. 88: 911-919, 2008). However, this method consumes a great deal of energy and results in isolating the proteins from the oil cake which is then low in constituents of nutritional interest.

An extraction with 90% ethanol followed by treatment of Jatropha oil cakes with NaHCO₃ at 121° C. for 20 minutes made it possible to reduce the phorbol ester content by close to 98% (Martinez-Herrera J. et al., Food Chem. 96 (2006), 80-89).

A basic treatment (aqueous solution of sodium hydroxide or of lime at 2%), followed by heat treatment at 121° C. for 30 minutes, carried out on Jatropha oil cakes, have made it possible to reduce their phorbol ester content by 89%, but the detoxification is not complete (Rakshit K D. et al., Food Chem. Toxicol. 46 (2008): 3621-3625).

Other plants contain similar toxic compounds in their seeds, in particular phorbol esters which are naturally present in many plants of the family Euphorbiaceae and the family Thymelaeaceae. By way of example, mention may be made of Euphorbia lathyris (mole plant or spurge) and Croton tiglium (purging croton) of the family Euphorbiaceae, or else Bertholletia excelsa (Brazil nut), Prunus dulcis (almond tree), Gossypium hirsutum (cotton), Linum usitatissimum (flax), Ceiba pentandra (kapok), Sapium indicum, S. Japonicum, Euphorbia frankiana, E. cocrulescence, E. ticulli, Croton spareiflorus, C. ciliatoglandulifer, Excoecaria agallocha and Homalanthus mutans. The seed detoxification method which is the subject of the invention can be generalized to all these plants.

It is therefore desirable to have a method for treating Jatropha seeds, and more generally any seed containing toxic compounds such as phorbol esters and/or curcin or other toxic proteins such as crotin (present in particular in the seeds of Croton tiglium) and abrin (in the seeds of Abrus precatorius), said method making it possible to simply and inexpensively inactivate these toxic compounds, which would then make possible, firstly, risk-free handling by human beings and, secondly, use of the oil cake, in particular Jatropha oil cake, in animal feed. This is particularly important for the economy of countries which are major producers of Jatropha oil (India, Madagascar, Brazil), since, while Jatropha oil has multiple industrial uses, Jatropha oil cakes are not yet used on an industrial scale, in particular because of the toxicity problems mentioned above.

The present invention proposes to provide a method for treating Jatropha seeds which limits the number of seed treatment steps and the handling of the oil cake, with a view to a continuous industrial application aimed at producing fatty acid esters, and which makes it possible to destroy “at source” the toxin (curcin) and the phorbol esters present in the Jatropha seeds, if possible while maintaining a nutritive value for the oil cake. The other advantage of the method compared with the conventional methods lies in the small amounts of water used. The operations for refining the crude oil for example consume very large amounts of water. This water saving is a major asset in the context of the development of this technology in developing countries and, to a lesser extent, in rich countries since water is tending to become an increasingly expensive commodity.

To this effect, the subject of the invention is a method for treating seeds containing toxic components such as curcin, abrin, crotin and/or phorbol esters, in particular Jatropha seeds, said seeds preferably having a degree of acidity of less than or equal to 3 mg KOH/g, said method comprising the following steps:
i) a seed processing step;
ii) a step of bringing the processed seeds into contact with a light anhydrous alcohol and an alkaline catalyst, under temperature and time conditions sufficient to allow the simultaneous extraction and transesterification of the vegetable oil, and producing a mixture comprising fatty acid esters and glycerol, and an oil cake.

The method according to the invention makes it possible to react “in planta” the light alcohol with the oil contained at the heart of the seed. In this method, the alcohol plays both the role of solvent and the role of reagent.

Characteristically, the seeds are processed by means of a series of operations comprising a step of flattening and a step of drying said seeds.

Preferably, said flattening step comprises triple flattening on smooth rollers, in particular for the hardest seeds such as Jatropha seeds.

According to the conditions used, the method according to the invention may directly produce a detoxified oil cake. In one embodiment variant, the oil cake is subjected to an additional drying step, under temperature and time conditions sufficient to inactivate the curcin and to break down the phorbol esters.

Advantageously, the oil cake thus treated loses its harmful nature and can be handled without danger by human beings so as to be used in animal feed.

In the context of the present invention, the term “Jatropha seeds” is intended to mean seeds from Jatropha plants, alone or as a mixture with seeds originating from at least one other oleaginous, oleaginous/protein-producing or protein-producing plant, the seeds or the seed mixture producing an oil containing at least 40% by weight of oleic acid. It would not be a departure from the context of the invention if the seeds used in the method according to the invention were to wholly or partly originate from genetically modified plants.

Oleaginous plants are cultivated specifically for their oil-producing seeds or fruits rich in fats, from which oil for food, energy or industrial use is extracted. Protein-producing plants belong to the botanical group of legumes, the seeds of which are rich in proteins. Oleaginous/protein-producing plants are legumes, the seeds of which also contain oil.

According to the invention, the term “detoxified Jatropha oil cake” is intended to mean a Jatropha oil cake having both:
a degree of curcin detoxification of at least 90% and preferably of at least 95%, with respect to activity, when this degree is measured by means of a quantitative test, or of 100% when this degree is measured by means of a qualitative test;
and a degree of decomposition of the phorbol esters of at least 95% and preferably of at least 99%, with respect to activity, when this degree is measured by means of a quantitative test, or of 100% when this degree is measured by means of a qualitative test.

Taking into account the results presented in the publication by Makkar H. P. S. et al, Plant Foods for Human Nutrition 1998, vol. 52, No. 1, pp. 31-36, a phorbol ester content of 0.11 mg/g corresponds to an edible (non-toxic) oil cake. Specialists in animal feed estimate in general that the oil cake is detoxified when it has a phorbol ester content of less than or equal to 0.3 mg/g and can be used in animal feed, in particular in a mixture with other feed materials.

The detoxified oil cakes according to the invention therefore have a phorbol ester content of at most 0.3 mg per g, preferably at most 0.11 mg per g of oil cake treated.

The term “degree of curcin detoxification” is intended to mean the percentage by weight of toxin inactivated in the oil cake.

The term “degree of decomposition” of the phorbol esters is intended to mean the percentage by weight of phorbol esters broken down in the oil.

Other characteristics and advantages will emerge from the detailed description of the method for treating Jatropha seeds according to the invention that follows.

A subject of the invention is a method for treating seeds containing toxic components such as curcin, abrin, crotin and/or phorbol esters, in particular Jatropha seeds, alone or as mixtures with seeds originating from at least one other oleaginous, oleaginous/protein-producing or protein-producing plant, said seeds preferably having a degree of acidity of less than or equal to 3 mg KOH/g, said method comprising the following steps:
i) a step of processing the seeds without prior hulling;
ii) a step of bringing the processed seeds into contact with a light anhydrous alcohol and an alkaline catalyst under temperature and time conditions sufficient to allow the simultaneous extraction and trans-esterification of the vegetable oil, and producing a mixture comprising fatty acid esters and glycerol, and an oil cake,
   characterized in that the seeds are processed by means of a series of operations comprising a step of flattening and a step of drying said seeds.

Another particularity of Jatropha seeds is linked to their high toxicity, due in particular to the presence of curcin and phorbol esters. After extraction of the oil, the curcin becomes concentrated in the oil cakes and the phorbol esters become concentrated in the oil and/or in the esters, making their handling by human beings problematic, or even dangerous.

The method according to the invention makes it possible to simultaneously solve numerous problems associated with the transesterification of Jatropha oil. This method advantageously makes it possible to go directly from the seed to the fatty acid esters, while avoiding the grinding, refining and purification steps and the production of by-products. The fatty acid esters obtained by means of the method according to the invention are particularly suitable for preparing biodiesel, as mentioned above. The method according to the invention makes it possible to obtain a fraction rich in fatty acid esters which lacks toxicity and can therefore be used free of risk, in particular for producing biodiesel. Moreover, the method produces detoxified oil cakes, which can be handled without danger by human beings and can be used in animal feed without risk of poisoning the animals.

### Seed Processing Step

The first step of the method according to the invention consists in processing the Jatropha seeds, used alone or as a mixture with other seeds of oleaginous, oleaginous/protein-producing or protein-producing plants. This processing is carried out on whole seeds. It comprises a first operation in which the seeds are flattened, followed by an operation in which the flattened seeds are dried.

The objective of the processing of the seed is to make the oil as accessible as possible to the alcohol, without, however, causing too much modification of its mechanical strength. This prevents the formation of a paste and of fines, which are respectively prejudicial to the implementation of a continuous process and to the final purification of the esters produced. Moreover, the processed seed should allow easy passage of the reaction fluid (alcohol/basic catalyst mixture) according to a simple percolation phenomenon.

According to one embodiment variant, fresh seeds are flattened on a mechanical flattener with smooth or fluted rollers.

The seeds thus flattened are dried, for example in a ventilated oven which is thermoregulated or in a continuous belt or rotary hot-air dryer. The drying time and the temperature are chosen so as to obtain a decrease in the moisture content of the seeds to values of less than or equal to 2% by weight. Preferably, the drying is carried out rapidly after flattening, in less than one hour, preferably after 5 to 10 minutes, at a temperature sufficient to reduce the moisture content of the seeds to 2% by weight or less.

The residual moisture content of the seed is determined by thermogravimetric analysis. The seed is ground beforehand, and then the ground material obtained is dried at 105° C. in a thermobalance until stabilization of the weight. The water content is expressed as percentage of the crude material.

In one preferred embodiment variant, step i) of processing the seeds also comprises a seed preheating operation, carried out before the flattening operation. This preheating operation gives the seed greater plasticity and therefore more effective crushing during flattening (gain in terms of contact surface, of alcohol percolation rate and therefore of extractive capacity of the alcohol). It is preferably carried out at a temperature of less than or equal to 100° C.

### Extraction and Transesterification Step

The seeds processed as described above are brought into contact with a light anhydrous alcohol and an alkaline catalyst under temperature and time conditions sufficient to allow the extraction and the transesterification of the vegetable oil, and producing a mixture comprising fatty acid esters and glycerol, and an oil cake.

The light alcohol used in step ii) is a lower aliphatic alcohol, such as methanol, ethanol, isopropanol and n-propanol, and is preferably methanol.

According to one embodiment variant, an organic solvent (cosolvent), which is miscible or immiscible with said light alcohol, is also added to the reaction medium. As cosolvent, mention may be made of: hexane, heptane, benzene, bicyclohexyl, cyclohexane, decalin, decane, hexane (Texsolve C), spirit, petroleum ether, kerosene, kerdane, diesel oil, paraffin oil, methylcyclohexane, Texsolve S or S-66, naphtha (Texsolve V), skellite, tetradecane, Texsolve (B, C, H, S, S-2, S-66, S-LO, V), supercritical CO₂, propane or butane which are pressurized, natural solvents such as terpenes (limonene, alpha- and beta-pinene, etc), ethers such as dimethyl ether or diethyl ether, ketones such as acetone, and mixtures of all these solvents.

The basic catalyst used in the method is chosen from the group: sodium hydroxide, alcoholic sodium hydroxide, solid sodium hydroxide, potassium hydroxide, alcoholic potassium hydroxide, solid potassium hydroxide, sodium or potassium methoxide, sodium or potassium ethoxide, sodium and potassium propoxide, and sodium and potassium isopropoxide.

The reaction is carried out in a fixed bed reactor. According to one embodiment, the fixed bed reactor is a thermoregulated percolation column fitted with a screen. A pump makes it possible to feed the column with alcohol-basic catalyst mixture. The alcohol and the catalyst are therefore added simultaneously to the reactor, which is maintained at a temperature ranging from 30 to 75° C., preferably less than or equal to 50° C., preferably less than 45° C., preferably approximately equal to 40° C. The catalyst/alcohol/seeds weight ratio is preferably included in the range 0.001 to 0.01/0.1 to 5/1, preferably in the range from 0.005 to 0.01/0.1 to 1/1, even more preferably in the range from 0.005 to 0.01/0.1 to 0.5/1.

In particular, a catalyst content of less than 0.001, or even less than 0.005, does not make it possible to obtain detoxified oil cakes, and, conversely, a content of greater than 0.01 leads to saponification and a poor ester yield.

The feed is carried out at the top of the bed; the reaction liquid then percolates through the bed and is then recovered in a store located downstream, under the bed. The liquid is sent back to the top of the bed, by pumping, so as to again diffuse through the bed. The duration of the alcohol/catalyst mixture recirculation cycle is from 15 to 60 minutes, preferably from 20 to 40 minutes. At the end of the cycle, the liquid feed is stopped. A part of the liquid still present in the soaked seeds is then recovered by simple draining.

The seeds are subsequently extracted and washed. For this, the column is fed with anhydrous alcohol which again diffuses by percolation without subsequent recirculation of the alcohol. Preferably, the alcohol extraction is carried out in 3 to 9 stages. The amount of solvent is injected for a given period of time (about 4 to 10 minutes), the liquid then being drained for a period of from 10 to 20 minutes. The liquid recovered can undergo a step of neutralization by addition of acid, and then a step of evaporation of the alcohol, so as to produce a mixture of phases consisting of a lighter phase rich in esters and a more dense phase rich in glycerol. Neither of these phases contains curcin.

The phase mixture is subjected to a decanting step (consisting, for example, of static decanting in one or more decanters in parallel or in series, centrifugal decanting, a combination of static or centrifugal decanting), making it possible to obtain an upper phase composed predominantly of fatty esters of a fatty acid (ester phase) and a lower phase composed predominantly of glycerin and water (glycerin phase).

The ester phase is subsequently subjected to a sequence of chemical reactions and/or separations/purifications aimed at recovering the fatty esters, comprising, in a known manner, a step of washing with water followed by a step of drying under vacuum.

The resulting fatty acid ester is intended in particular for the preparation of biodiesel.

The other product resulting directly from the method according to the invention is the Jatropha oil cake.

According to one embodiment variant, the reduced-fat oil cake soaked with alcohol is dried, for example in a ventilated oven, for 4 h, at a temperature of less than or equal to 200° C., preferably less than or equal to 150° C. and even more preferentially less than or equal to 120° C. The aim of this drying step is also to destroy the curcin remaining in the oil cake. In parallel, this drying step makes it possible to remove, from the oil cake, the solvent (alcohol) used during the extraction.

According to another embodiment variant, the method according to the invention does not comprise a step of drying the oil cake at high temperature (temperature above 120° C.); according to the conditions used, the curcin can be inactivated by virtue of the physical and/or chemical treatments applied to the Jatropha seeds during the processing and extraction/trans-esterification steps described above, such that the operation for drying the oil cake at high temperatures becomes needless. In this case, the method comprises only a step of drying the oil cake at temperatures of less than 120° C., intended to remove the solvent (alcohol) used during the extraction, in order to allow said oil cake to be used in animal feed.

The quantitative test for determining the toxic nature of the oil cakes and also of the liquid phases recovered after the extraction/transesterification step is the acute oral toxicity test.

The publication Makkar H. P. S. et al. J. Agric. Food Chem. 45: 8, 1997, 3152-3157 describes a quantitative curcin test (hemagglutination test) and also a method for quantitatively assaying the phorbol esters (successive extractions with dichloromethane, followed by analysis by HPLC).

The method according to the invention can without difficulty be implemented continuously on the industrial scale, for example by means: of a continuously operating, moving belt reactor-extractor (of De Smet extractor type); of a rotary filter or of a centrifuge. Preferably, the reactive grinding is carried out with methanol in a direction countercurrent with respect to the oil cake, over several consecutive stages. Preferably, the alcohol extraction is carried out in 3 to 9 stages.

The reactive grinding method according to the invention is particularly suitable for mixtures of seeds, such as soybeans, castor beans, safflower seeds or rape seeds. Advantageously, the oil cake of Jatropha, which cannot be used pure, but as a mixture with other protein producers, is then directly mixed with other protein sources.

A starting mixture consisting of Jatropha seeds (rich in oil) and soybeans (rich in proteins) in a proportion of 1:10 results, by means of the method according to the invention, in a mixture of fatty acid methyl esters containing from 15 to 40% by weight of oleic acid methyl ester, particularly suitable for use as a biofuel.

The method for reactive grinding of seeds according to the invention has many advantages.

By virtue of the step of specific processing of the seeds, it is possible to increase the contact surface for better percolation of the alcohol-catalyst mixture and therefore better extraction of the lipids and their subsequent conversion to esters. No prior impregnation of the processed seeds is necessary. The ester fraction obtained from the mixture comprising fatty acid esters and glycerol is particularly suitable for the production of biodiesel.

Starting from whole seeds makes it possible:
firstly, to greatly limit the formation of fines, making the subsequent filtration steps easier, and limiting the toxic risk since the dry fines have a tendency to dissipate/disperse in the ambient air;
and, secondly, to maintain a good mechanical strength of the bed of flattened seeds (that will form the oil cake), this being a very advantageous property if it is desired to carry out the reaction in a continuous mode.

The oil cakes are obtained directly from the seeds, according to the method of the invention. These oil cakes are devoid of toxicity with respect to human beings and can therefore be handled risk-free. Moreover, these oil cakes keep their physical integrity (cohesion, mechanical strength) and have an advantageous nutritive value, which allows them to be used in animal feed.

The invention and the advantages thereof will be understood more clearly on reading the examples hereinafter given purely by way of illustration.

### Reactive Grinding of Jatropha Seeds

TABLE 1
characterization of the Jatropha seed tested

| | Jatropha seed |
|---|---|
| Characteristics | (November 2009) |
| Moisture content, % | 7.5 |
| Fat, % DM | 35.0 |
| Acidity of the fat, mg KOH/g | 1.8 |
| Fatty acid distribution (relative %) | |
| Palmitic (C16:0) | 12.8 |
| Palmitoleic (C16:1) | 0.7 |
| Stearic (C18:0) | 6.4 |
| Oleic (C18:1) | 42.2 |
| Linoleic (C18:2) | 37.2 |
| Linolenic (C18:3) | 0.2 |
| Arachidic (C20:0) | 0.2 |
| Eicosenoic (C20:1) | 0.3 |
| Phorbol ester content, mg/g | 3.6 |

In terms of the oil content and the fatty acid distribution, the Jatropha seed is in accordance with the literature (Biodiesel & Jatropha Cultivation, S. Lele, 2006). Its acidity of less than 2 mg KOH/g allows it to be used in the method according to the invention.

Finally, by virtue of its phorbol ester content, very much higher than 0.3 mg/g, the Jatropha seed belongs to the toxic varieties.

### Cosolvent-Free Reactive Grinding Test

Reactive Grinding of Jatropha Seeds with Methanol Extraction Carried Out in 3 Stages (Method Carried Out in a Fixed Bed Reactor)

500 g of fresh unhulled Jatropha seeds were processed on a Henry flattener with smooth rollers having a fixed gap of 0.05 mm. The flattened seeds are in the form of petals 0.2 mm thick and 0.2 mm in diameter approximately. The flattened seeds were dried at 60° C. for 16 h. Their final water content is 1.3% by weight.

In a thermoregulated fixed-bed percolation column, these flattened and dried seeds were brought into contact with a mixture of sodium hydroxide and methanol, containing 0.5% by weight of sodium hydroxide relative to the seed and having an alcohol/seed weight ratio of 1.15. The extraction and transesterification reactions are carried out at a temperature of 50° C. for minutes. The bed is drained for 15 minutes. Extraction and washing of the seeds are then carried out with methanol in three stages and in a countercurrent direction.

The liquid phase obtained is subjected to decanting in order to recover a lighter phase rich in esters and a more dense phase rich in glycerol. The ester yield is 77.2%.

The oil cake obtained is subjected to drying in a ventilated oven at 120° C. for 4 h. It is noted that the reduced-fat oil cake is relatively well depleted, with a residual fat content of 5.4% (determined in accordance with standard NF ISO 659).

Tests carried out in order to assay the toxic compounds in the oil cake show that the oil cake is detoxified.

### Optimization of the Reaction in a Stirred-Bed Reactor

In order to test the reactivity of the Jatropha seed, tests are carried out in a closed stirred-bed reactor in which the reaction is carried out on a ground seed. In greater detail, the stirred-bed reaction is carried out under the following conditions:
1. Drying of the whole seed at 100° C. for 16 h.
2. Grinding of the seed at ambient temperature in the solution in methanolic sodium hydroxide for 5 minutes.
3. Maintaining of the stirring in a reactor heated at 50° C. for 30 minutes.
4. Filtration on a Büchner filter (simulation of a rotary filter) followed by washing with anhydrous methanol.

TABLE 2
Mass balance for the fractionation of the Jatropha seed in a stirred-bed
reactor

| | TEST LA10-01 | TEST LA10-02 |
|---|---|---|
| Catalyst content (vs | 0.5 | 1.5 |
| seed), % by mass | | |
| Methanol/seed mass ratio | 1.5 | 1.5 |
| Test balance | yield (%) | yield (%) |
| Dry extract yield (1), % | 34.0 | 110.0 |
| Methyl ester yield, % | zero | 75.1 |
| Loss in terms of esters** | 100 | 24.9 |
| (calculated value) | | |
| Crude glycerin yield, % | — | 453 |

**loss in terms of esters = [theoretical mass of esters ] − [mass of esters produced] − [potential mass of esters in the reduced-fat oil cake]
(1): The dry extract yield is the ratio of the dry extract obtained after evaporation of the miscella to the sum of the theoretical ester and of the theoretical glycerin

In the first test (LA10-01), the amount of dry extract of the miscella obtained represents only 34% of the theoretical amount expected. Furthermore, this dry extract, firstly, is not a two-phase extract (absence of glycerin) and, secondly, has a neutral pH. Consequently, under these conditions, the extractability and the reactivity of the lipids are not optimal.
In the second test (LA10-02), carried out with 3 times more catalyst used, the dry extract content of the miscella is at a maximum with probably other extracted products (yield=110%). The ester yield is 75%, while the glycerol yield (>>400%) attests to the formation of soaps. Therefore it clearly appears that the amount of catalyst is still too high. The optimum in terms of catalyst is therefore indeed intermediate between 0.5 and 1.5%, and preferably between 0.5 and 1% by mass, relative to the mass of seed used.
From the qualitative point of view, the esters produced have reasonable glyceride contents (table 3).

TABLE 3
Analytical balance of Jatropha esters

| | Method | TEST LA10-02 |
|---|---|---|
| Acid number (mg KOH/g) | EN14104 | nc* |
| Monoglyceride content (%) | EN14104 | 0.8 |
| Diglyceride content (%) | EN14104 | 0.7 |
| Triglyceride content (%) | EN14104 | nd** |

*analysis not carried out
**not detected

### Implementation of the Reaction in a Fixed-Bed Reactor After Double Flattening

In parallel to the tests in a stirred-bed reactor, tests were carried out on a fixed-bed reactor. In summary, the fixed-bed reaction is carried out under the following conditions:
1. Flaking of the fresh Jatropha seed on a fluted-roller flattener. The rollers are first apart (5.0 mm) in order to allow a first crushing of the seed. The crushed seed is then passed through the flattener again, with rollers as tightly together as possible (0.1 mm).
2. The flakes are then dried for 16 h at 100° C.
3. The flakes are introduced into the percolation column.
4. The methanolic sodium hydroxide solution is then recirculated over the bed for 30 minutes at 50° C.
5. The miscella is then withdrawn and the flake bed is then washed with 5 successive washes using methanol at 50° C. (5 minutes per wash).

Initially, the processing of the seed was carried out only on a fluted-roller flattener.

TABLE 4
Mass balance for the fractionation of the
Jatropha seed on a fixed bed

| | TEST | TEST | TEST |
|---|---|---|---|
| | 09-E43 | 10-E01 | 10-E02 |
| 1^{st} flattening (pre- | Yes | Yes | Yes |
| crushing) on a flattener | | | |
| with separated fluted | | | |
| rollers | | | |
| 2^{nd} flattening with | Yes | Yes | Yes |
| fluted rollers tightly | | | |
| together | | | |
| Flake thickness | 0.5-0.7 mm | 0.5-0.7 mm | 0.5-0.7 mm |
| Catalyst content (vs | 0.3 | 0.6 | 1.5 |
| flake), % | | | |
| Methanol/seed mass ratio | 2 | 2 | 2 |
| | | | Amount (g) |
| Test balance | Yield (%) | | Yield (%) |
| Seed mass used, g | 350 | 350 | 350 |
| | | | — |
| Dry extract yield (1), % | 36.0 | 49.0 | 64.0 |
| Methyl ester yield, % | No phase | 29.1 | No phase |
| | separation | | separation |
| Losses in terms of | nc* | 56.4 | 33.0 |
| methyl esters in the oil | | | |
| cake, % | | | |
| Other losses in terms of | nc* | 14.5 | 66.9 |
| esters in terms of | | | |
| methyl esters** | | | |
| (calculated value), % | | | |
| Crude glycerin yield, % | 395 | 249 | 699 |

*not carried out
**loss in terms of esters = [theoretical mass of esters] − [mass of esters produced] − [potential mass of esters in the reduced-fat oil cake]
(1): The dry extract yield is the ratio of the dry extract obtained after evaporation of the miscella to the sum of the theoretical ester and of the theoretical glycerin.

The 3 tests carried out reveal low contents of extracted matter in the miscellas (36, 49 and 64%), clearly indicating that the processing of the flake (morphology, thickness) is not optimal.
In the presence of 0.3% of catalyst, the pH of the miscella obtained is neutral and, moreover, no ester formation is observed.
When the amount of catalyst is doubled, there is indeed ester formation (yield 29%), but the oil cake remains very rich in lipids and the high glycerin yield indicates a hyper production of soaps.
When the amount of catalyst is tripled, the miscella is very basic (pH>12) and the medium is again single-phase, the esters being saponified (explosion of the glycerin yield>>600%).
From the qualitative point of view, the esters produced during test 10-E01 have reasonable glyceride contents (table 5).

TABLE 5
Analytical balance of Jatropha esters

| | Method | TEST 10-E01 |
|---|---|---|
| Acid number (mg KOH/g) | EN14104 | nc |
| Monoglyceride content (%) | ARKEMA | 0.8 |
| Diglyceride content (%) | ARKEMA | 0.4 |
| Triglyceride content (%) | ARKEMA | nd |

* analysis not carried out
** not detected

Thus, it is envisioned to optimize the morphology of the flake by adding a step of flattening on smooth rollers in order to obtain a more extractable oil cake.

### Optimization of the Preparation of the Jatropha Flake After Triple Flattening

The flake preparation mode is improved in order to reduce the loss of fat in the oil cake. The flaking is carried out under the following conditions:
1. Flaking of the fresh Jatropha seed on a fluted-roller flattener. The rollers are first apart in order to allow a first crushing of the seed (0.5 mm). The crushed seed is then passed through the flattener again with the rollers as tightly together as possible (0.1 mm). This flake is then flattened on smooth rollers with a spacing of 0.05 mm. The thickness of the flake obtained is approximately 0.2 to 0.3 mm.
2. The flakes are then dried for 16 h at 100° C.
3. The flakes are then introduced into the percolation column.
4. The methanolic sodium hydroxide solution is then sent back over the bed for 30 minutes at 50° C.
5. The miscella is then withdrawn and the flake bed is then washed with five successive washes using fresh methanol at 50° C. (5 minutes per wash).

TABLE 6
Mass balance for the fractionation of the Jatropha seed on a fixed bed after triple flattening

| TEST | 10-E08 | 10-E11 | 10-E13 | 10-E12 | 10-E14 | 10-E06 |
|---|---|---|---|---|---|---|
| 1^{st} flattening (pre-crushing) on a | Yes | Yes | Yes | Yes | Yes | Yes |
| flattener with fluted rollers apart | | | | | | |
| 2^{nd} flattening with fluted rollers tightly | Yes | Yes | Yes | Yes | Yes | Yes |
| together | | | | | | |
| 3^{rd} flattening with smooth rollers tightly | Yes | Yes | Yes | Yes | Yes | Yes |
| together | | | | | | |
| Drying of the flake at 100° C. for 16 h | Yes | Yes | Yes | Yes | Yes | Yes |
| Flake thickness (mm) | 0.2-0.3 | 0.2-0.3 | 0.2-0.3 | 0.2-0.3 | 0.2-0.3 | 0.2-0.3 |
| Catalyst content (vs flake), % | 0.3 | 0.6 | 0.7 | 0.8 | 0.9 | 1.0 |
| Methanol/seed mass ratio | 2 | 2 | 2 | 2 | 2 | 2 |
| Dry extract yield (1), % | 31 | 77 | 91 | 98.9 | 99.3 | 97 |
| Ester/glycerin phase separation | no | yes | yes | yes | yes | no |
| Methyl ester yield, % | nc* | 44.4 | 67.3 | 71.0 | 72.5 | nc* |
| Crude glycerin yield, % | 338 | 405 | 327 | 361 | 366 | 1067 |
| Losses in terms of methyl esters in the | 53.9 | 9.7 | 16.7 | 7.5 | 4.2 | 6.3 |
| oil cake, % | | | | | | |
| Other losses in terms of esters in terms | 46.1 | 45.9 | 16.0 | 21.5 | 23.3 | 93.7 |
| of methyl esters** (calculated value), % | | | | | | |

(1): The dry extract yield is the ratio of the dry extract obtained after evaporation of the miscella to the sum of the theoretical ester and of the theoretical glycerin.
*could not be carried out
**loss in terms of esters = [theoretical mass of esters] − [mass of esters produced] − [potential mass of esters in the reduced-fat oil cake]

TABLE 7
Analytical balance of Jatropha esters

| | | TEST | TEST | TEST | TEST | TEST | TEST |
|---|---|---|---|---|---|---|---|
| | Method | 10-E08 | 10-E11 | 10-E13 | 10-E12 | 10-E14 | 10-E06 |
| Acid number (mg KOH/g) | EN14104 | nd | 0.33 | 0.17 | 0.15 | 0.14 | nd |
| Monoglyceride content (%) | ARKEMA | nd | 0.77 | 0.57 | 1.11 | 0.68 | nd |
| Diglyceride content (%) | ARKEMA | nd | 0.35 | <0.1 | <0.1 | <0.1 | nd |
| Triglyceride content (%) | ARKEMA | nd | <0.1 | <0.1 | <0.1 | <0.1 | nd |

### Comments:

the triple flattening provides a boost in terms of lipid extractability since, in the presence of at least 0.8% of catalyst, the dry extract yields are found to be greater than 96%;
the maximum ester yield observed is 71%, even though the extractability is very high (98%). Furthermore, the high glycerin yield clearly reflects a still substantial lipid saponification;
on the other hand, from the qualitative point of view, the ester of test 10-E12 is not very acidic and is very low in monoglycerides and corresponds, on the basis of these criteria, to a biodiesel quality. Generally, the final acidity of the esters decreases with the amount of basic catalyst used;
under the conditions of test 10-E12, the miscella before evaporation is clear, but still strongly basic. Thus, it is presumed that, after evaporation of the methanol, the high concentration of catalyst leads to parasitic saponification of the esters. For this reason, the miscella will be neutralized before evaporation of the methanol in the next test.

### Glycerin Neutralization Test

### Procedure:

1. Flaking of the fresh Jatropha seed on a fluted-roller flattener. The rollers are first apart in order to allow a first crushing of the seed (0.5 mm). The crushed seed is then passed through the flattener again with the rollers as tightly together as possible (0.1 mm). This flake is then flattened on smooth rollers with a spacing of 0.05 mm. The flake thickness obtained is approximately 0.20 to 0.30 mm.
2. The flakes are then dried for 16 h at 100° C.
3. The flakes are introduced into the percolation column.
4. The methanolic sodium hydroxide solution is then sent over the bed again for 30 minutes at 50° C.
5. The miscella is then withdrawn and the flake bed is then washed with 5 successive washes using fresh methanol at 50° C. (5 minutes per wash).
6. The miscellas are combined and conveyed to the distillation (90° C., 100 mbar).
7. Once the methanol has been evaporated off, the glycerin and the ester are separated by decanting.
8. The ester is washed to neutrality and then dried under vacuum (90° C., 20 mbar).
9. The crude glycerin is treated with an aqueous solution of sulfuric acid in which the acid represents 5% of the mass of crude glycerin and the water represents 100% of the mass of glycerin. The mixture is kept stirring at 90° C. for 30 min. The mixture is then separated by decanting. The fatty phase (fatty acids) is washed to neutrality and dried under vacuum (90° C., 100 mbar).

TABLE 8
Effect of the reaction temperature

| | TEST |
|---|---|
| | 10-E20 |
| 1^{st} flattening (pre-crushing) on a flattener | Yes |
| with fluted rollers apart | |
| 2^{nd} flattening with fluted rollers tightly | Yes |
| together | |
| 3^{rd} flattening with smooth rollers tightly | Yes |
| together | |
| Drying at 100° C. for 16 h | Yes |
| Flake thickness | 0.2-0.3 mm |
| Catalyst content (vs flake), % | 0.8 |
| Reaction and extraction temperature, ° C. | 50 |
| Methanol/seed mass ratio | 2 |
| Dry extract yield (1), % | 100 |
| Ester/glycerin phase separation | Yes |
| Methyl ester yield, % | 67.8 |
| Crude glycerin yield before neutralization, % | 421 |
| Yield of fatty acids resulting from | 25.5 |
| neutralization of the crude glycerin, % | |
| Crude glycerin yield after neutralization, % | 143 |
| Losses in terms of methyl esters in the oil | 6.7 |
| cake, % | |
| Other losses in terms of esters in terms of | 0.0 |
| methyl esters** (calculated value), % | |

(1): The dry extract yield is the ratio of the dry extract obtained after evaporation of the miscella to the sum of the theoretical ester and of the theoretical glycerin.
*could not be carried out
**loss in terms of esters = [theoretical mass of esters] − [mass of esters produced] − [potential mass of esters in the reduced-fat oil cake]

### Comments:

The sulfuric acid treatment of the crude glycerin clearly makes it possible to extract glycerin and 25% of free fatty acids (ex-soaps) and to bring the overall glycerin yield back to a more conventional level (143%). These fatty acids may be recycled into the process, in particular by esterification in the presence of an acid catalyst (sulfuric acid) and of methanol;
under the conditions of acid treatment of the glycerin, it is noted that the esters are not hydrolyzed (cf. table 9: analysis of the esters resulting from test 10-E20 FFA), but that they are very acidic (AN=19.4, i.e. approximately 10% of free fatty acids) and relatively loaded with residual glycerides;
as regards the methyl ester phase resulting from test 10 E20, recovered after removal of the glycerin coproduced, it still remains relatively loaded with glycerides.

TABLE 9
Analytical balance of the esters

| | | TEST 10-E20 | TEST 10-E20 |
|---|---|---|---|
| Methyl ester | Method | ester | “Free fatty acids” |
| Acid number | EN14104 | 0.16 | 19.4 |
| (mg KOH/g) | | | |
| Monoglyceride | EN14104 | 0.95 | 2.41 |
| content (%) | | | |
| Diglyceride | EN14104 | <0.1 | <0.1 |
| content (%) | | | |
| Triglyceride | EN14104 | <0.1 | <0.1 |
| content (%) | | | |

### Reactive Grinding Test in the Presence of Ethanol

A reactive grinding method was carried out in the presence of ethanol under the conditions presented in table 10.

TABLE 10
Conditions and mass balance for the method of
reactive grinding in the presence of ethanol

| | TEST |
|---|---|
| | 10-E26 |
| 1^{st} flattening (pre-crushing) on a flattener | Yes |
| with fluted rollers apart | |
| 2^{nd} flattening with fluted rollers tightly | Yes |
| together | |
| 3^{rd} flattening with smooth rollers tightly | Yes |
| together | |
| Drying of the flake at 100° C., 16 h | Yes |
| Flake thickness | 0.2-0.3 mm |
| Catalyst content (vs flake), % | 0.8 |
| Reaction and extraction temperature, ° C. | 50 |
| Ethanol/seed mass ratio | 2 |
| Dry extract yield (1), % | 94.1 |
| Ester/glycerin phase separation | No phase |
| | separation |
| Ethyl ester yield, % | nc* |
| Losses in terms of ethyl esters in the oil | 12.1 |
| cake, % | |
| Other losses in terms of esters in terms of | 100 |
| ethyl esters** (calculated value), % | |

(1): The dry extract yield is the ratio of the dry extract obtained after evaporation of the miscella to the sum of the theoretical ester and of the theoretical glycerin.
*could not be carried out
**loss in terms of esters = [theoretical mass of esters] − [mass of esters produced] − [potential mass of esters in the reduced-fat oil cake]

### Comments:

under the conditions of the test, the medium is too saponifying since the reaction medium is in a nonextractable pasty form (soaps);
with regard to the potential of residual ester in the oil cake, ethanol appears to extract less fat than methanol (12.1% vs 7.5% in test 10-E12);
despite these observations, the “ethanolic” oil cake was analyzed in order to determine its phorbol ester content (table 17).
   Reactive Grinding Tests in the Presence of a Cosolvent Test with a Methanol/Hexane (28/72) (m/m) Mixture

In the context of these tests, given the high volatility of hexane, the reaction temperature was lowered to 40° C.

TABLE 11
Influence of the presence of a methanol/hexane (28/72) (m/m) cosolvent

| | TEST | | |
|---|---|---|---|
| | 10-E21 | 10-E19 | 10-E18(2) |
| 1^{st} flattening (pre-crushing) on flattener with fluted rollers | Yes | Yes | Yes |
| apart | | | |
| 2^{nd} flattening with fluted rollers tightly together | Yes | Yes | Yes |
| 3^{rd} flattening with smooth rollers tightly together | Yes | Yes | Yes |
| Drying of the flake at 100° C., 16 h | Yes | Yes | Yes |
| Flake thickness | 0.2-0.3 mm | 0.2-0.3 mm | 0.2-0.3 mm |
| Catalyst content (vs flake), % | 0.5 | 0.7 | 0.9 |
| Reaction and extraction temperature, ° C. | 40 | 40 | 40 |
| Solvent (hexane + methanol)/seed mass ratio | 2 | 2 | 2 |
| Dry extract yield (1), % | 100.1 | 103.3 | 101.6 |
| Ester/glycerin phase separation | Yes | Yes | Yes |
| Methyl ester yield, % | 101.4 | 98.2 | 107.4* |
| Crude glycerin yield, % | 87.8 | 154 | 43.9* |
| Losses in terms of methyl esters in the oil cake, % | 3.3 | 3.5 | 3.0 |
| Other losses in terms of esters in terms of methyl esters** | −4.7 | −1.7 | −10.4 |
| (calculated value), % | | | |

(1): The dry extract yield is the ratio of the dry extract obtained after evaporation of the miscella to the sum of the theoretical ester and of the theoretical glycerin.
(2) Relative to test 10-E18, the ester yield is higher than the theoretical yield, and the glycerin yield is abnormally low. As it happens, it is found that the ester phase has an emulsified appearance and therefore seems to retain nondecantable glycerin.
*could not be carried out
**loss in terms of esters = [theoretical mass of esters] − [mass of esters produced] − [potential mass of esters in the reduced-fat oil cake]

### Comments:

In the presence of the methanol-hexane mixture, the oil cakes are correctly depleted.
While the ester yield in test 10-E19 appears to be high, it is found that said esters are loaded with glycerides (table 12), indicating that the reaction medium (depending on the methanol/hexane ratio) is not transesterifying enough. This result is, moreover, confirmed regardless of the catalyst content. It is also noted that, at very high catalyst content (0.9%), the medium even becomes saponifying.

TABLE 12
Analytical balance of esters

| | Method | 10-E21 | 10-E19 | 10-E18 |
|---|---|---|---|---|
| Acid number (mg KOH/g) | EN14104 | 0.43 | 0.17 | 0.18 |
| Monoglyceride content (%) | EN14104 | 2.29 | 1.4 | 2.2 |
| Diglyceride content (%) | EN14104 | 8.53 | 2.8 | 3.9 |
| Triglyceride content (%) | EN14104 | <0.1 | <0.1 | <0.1 |

### Perspectives:

A test with a higher methanol content was therefore carried out:

### Reactive Grinding Tests in the Presence of a Hexane/Alcohol Mixture Enriched in Methanol:

TABLE 13
Influence of methanol content

| | TEST | |
|---|---|---|
| | 10-E24 | 10-E-25 |
| 1^{st} flattening (pre-crushing) on flattener with | Yes | Yes |
| fluted rollers apart | | |
| 2^{nd} flattening with fluted rollers tightly | Yes | Yes |
| together | | |
| 3^{rd} flattening with smooth rollers tightly | Yes | Yes |
| together | | |
| Drying of the flake at 100° C., 16 h | Yes | Yes |
| Flake thickness | 0.2-0.3 mm | 0.2-0.3 mm |
| Catalyst content (vs flake), % | 0.7 | 0.7 |
| Reaction and extraction temperature, ° C. | 40 | 40 |
| Methanol/hexane mass ratio | 90/10 | 50/50 |
| Solvent (methanol/hexane)/seed mass ratio | 2 | 2 |
| Dry extract yield(1), % | 102.2 | 104.3 |
| Ester/glycerin phase separation | Yes | Yes |
| Methyl ester yield, % | 74.4 | 88.3 |
| Crude glycerin yield, % | 379 | 263 |
| Losses in terms of methyl esters in the oil | 10.9 | 2.8 |
| cake, % | | |
| Other losses in terms of esters in terms of | 14.7 | 8.9 |
| methyl esters** (calculated value), % | | |

(1): The dry extract yield is the ratio of the dry extract obtained after evaporation of the miscella to the sum of the theoretical ester and of the theoretical glycerin.
*could not be carried out
**loss in terms of esters = [theoretical mass of esters] − [mass of esters produced] − [potential mass of esters in the reduced-fat oil cake]

### Comments:

in the proportions 90/10, the addition of a large amount of methanol significantly alters the lipid extractability (cf. oil cake ester potential) and therefore the methyl ester yield. Under these conditions, the medium is however more transesterifying than in the presence of the methanol/hexane mixture=28/72 (table 14, cf. % glycerides);
when the hexane is increased (50/50 mixture), the oil cake is, finally, correctly depleted (2.8% of losses of methyl esters in the oil cake). In fact, the overall methyl ester yield is much improved (88.3%), clearly indicating that the transesterifying activity is regained under these conditions;
from the qualitative point of view (table 14), the methyl esters produced are not very acidic even though their monoglyceride content is still high (probably due to a retro-conversion of the methyl esters to glycerides).

TABLE 14
Analytical balance of the esters

| | Method | 10-E24 | 10-E25 |
|---|---|---|---|
| Acid number (mg KOH/g) | EN14104 | 0.17 | 0.20 |
| Monoglyceride content (%) | EN14104 | 1.26 | 1.36 |
| Diglyceride content (%) | EN14104 | 0.2 | 0.3 |
| Triglyceride content (%) | EN14104 | <0.1 | <0.1 |

### Evaluation of the Detoxifying Effect of the Method by Measuring the Change in Phorbol Ester Content

The preparation of the samples and also the assaying of the phorbol esters were carried out according to the method of Makkar (Makkar H P S, Becker K, Sporer F, Wink M (1997) Studies on nutritive potential and toxic constituents of different provenances of Jatropha curcas. J Agric Food Chem 45:3152-3157).

### 3.1 Sample Preparation

The liquid samples are diluted in methanol and then injected. For the solid samples, the phorbol esters are first of all extracted with a pestle and mortar in the presence of methanol. The alcoholic extracts obtained are then analyzed by high performance liquid chromatography.

### 3.2 Operating Conditions:

### Chromatographic Conditions:

Detector: diode array (peak integration at 280 nm).
Column: C18 reverse phase (LiChrospher 100, 5 mm), 250×4 mm+precolumn.
Oven: 22° C. (amb T).
Eluents:
   B=Acidified water (1.75 ml H₃PO₄ (85%) in 1 litre of demineralised water).
   A=acetonitrile

### 3.3 Results

Reactive Grinding with Methanol on Triple-Flattened Flake with Retreatment of the Glycerine (Test 10E20)

TABLE 15
Phorbol ester distribution in a fractionation
with retreatment of the glycerine/test 10E20

| | | | | PE |
|---|---|---|---|---|
| | | PE | PE | distribution |
| | | content | mass | (in % PEs of |
| | Mass g | mg/g | mg | the seed) |
| Seed used | 346.5 | 3.5 | 1230 | — |
| Dried flake | 346.5 | 2.6 | 925 | 75.2 |
| Methyl ester | 82.2 | 4.7 | 386 | 31.4 |
| Ester resulting from | 30.9 | 7.6 | 235 | 19.1 |
| the retreated glycerin | | | | |
| (FFA) | | | | |
| Retreated glycerin | 17.3 | 2.7 | 47 | 3.8 |
| Oil cake | 216.1 | 0.3 | 65 | 5.3 |
| Total losses | — | — | 286 | 40.4 |

### Comments:

the losses of phorbol esters (PEs) after flaking and drying are approximately 25%. The PEs appear to be relatively sensitive to increased temperature. Overall, the method results in PE losses of 40%;
approximately ⅓ of the PEs of the seed are found in the methyl esters and 5% in the dried oil cake;
in view of the PE contents in the esters directly resulting from the method or after acid retreatment of the glycerin, the PEs appear to have a relative affinity for lipophilic compounds (methyl ester phase);
the residual content in the oil cake is 0.3 mg/g, i.e. very close to the values of the non-toxic Mexican varieties (0.1 mg/g). There is therefore clearly a positive and detoxifying effect of the method according to the invention.
   Reactive Grinding with Cosolvent on Triple-Flattened Flake:

TABLE 16
Phorbol ester distribution in a method with
cosolvent/test 10E25

| | | | | PE |
|---|---|---|---|---|
| | | PE | PE | distribution |
| | | content | mass | (in % of PEs |
| | Mass g | mg/g | mg | of the seed) |
| Seed used | 346.5 | 3.5 | 1230 | — |
| Methyl ester | 107.1 | 5.5 | 589 | 47.9 |
| Glycerin | 31.8 | 2.7 | 86 | 7.0 |
| Oil cake | 207.6 | 0.3 | 62 | 6.7 |
| Losses | — | — | 493 | 38.4 |

### Comments:

in the presence of cosolvent (hexane), the method according to the invention produces an oil cake with a low PE content (0.3 mg/g), whereas the methyl esters capture 50% of the PEs of the seed. This result appears to confirm the relatively liposoluble nature of PEs;
here again, overall, the method results in PE losses of 40%.

Moreover, with regard to the low PE contents in the oil cakes resulting from the method, it may be concluded that said method is detoxifying in nature. It can also be readily considered that this content will be further improved at the industrial level, comprising drying of the flake and of the oil cake in a toaster.

### Transformation of the Jatropha Seed by Means of a Conventional Method (Pressing+Semi-Refining of the Oil+Methanolysis; Comparative Example)

The Jatropha seed is ground by pressing in order to obtain a crude press oil and an oil cake.

For this, the seed undergoes the following steps:

Grinding:
The seed is crushed on a fluted-roller flattener.
The flakes are then conveyed to the heated Taby press with no die.
The crude press oil obtained is then filtered through an 11 μm cellulose filter.

Before being esterified, the crude oil undergoes semi-refining which comprises the following steps:
Mucilage removal
Neutralization

Mucilage Removal:
the oil is heated to 65° C.;
when the temperature of 65° C. has been reached, a mixture composed of 1.5% of phosphoric acid and 6% of water (% by mass relative to the mass of dry oil) is added;
the mixture is then kept stirring for 10 min. The temperature is then increased to 75° C. and maintained for 30 min. The mixture is then centrifuged for 5 min at 4500 rpm.

Neutralization:
The dephosphorized oil is neutralized with an aqueous solution of sodium hydroxide composed of 6% water (relative to the mass of oil) and of sodium hydroxide required to neutralize all the free fatty acids with an excess of 5%. The sodium hydroxide solution is added to the dephosphorized oil heated to 75° C., and the mixture is maintained for 10 minutes. The temperature is then increased to 90° C. for 30 minutes. The mixture is then centrifuged for 5 min at 4500 rpm in order to remove the soapy heavy phase. The oil is then washed to neutrality with demineralized water by successive additions of 20% water with stirring for 5 min and centrifugation for 5 min at 4500 rpm. The oil is then dried under vacuum at 90° C. (20 mbar).

The semi-refined oil is then transesterified with methanol in the presence of a basic catalyst.

Transesterification and Purification of Esters
in a first step, the semi-refined oil is brought into contact with anhydrous methanol in an oil/methanol mass ratio of 5/1;
the mixture is then brought, with stirring, to the reflux temperature of methanol (65-70° C.);
sodium methoxide (methanolic solution of catalyst at 25%) is then gradually added (3 additions) in an oil/methanol/catalyst mass ratio of 5/1.02/0.03;
the mixture is then refluxed with stirring for 2 hours;
after having left the glycerin (heavy phase) to decant for 1 hour, the latter is removed by drawing off from the reactor;
the ester phase is then washed to neutrality with demineralized water (each wash is carried out with stirring for 15 min at 90° C.);
finally, the esters are dried under vacuum at 90° C. (20 mbar).

TABLE 17
Balance for the conventional grinding of the
Jatropha seed

| | TEST |
|---|---|
| | 10-E27 |
| Pre-crushing on a flattener with fluted | Yes |
| rollers apart | |
| Flattening with fluted rollers tightly | No |
| together | |
| Flattening with smooth rollers tightly | No |
| together | |
| Drying 100° C. 16 h | No |
| Taby press with no die | Yes |
| Press oil/oil cake proportion (ms) | 21/79 |
| Press yield, % | 60.2 |
| Semi-refining yield | 97% |
| Transesterification yield | 98% |

TABLE 18
Analytical balance of the Jatropha oils and
esters obtained by means of the conventional method

| | | Crude | Semi- | |
|---|---|---|---|---|
| | | press | refined | Methyl |
| | Method | oil | oil | ester |
| Acid number (mg KOH/g) | EN14104 | 2.0 | 0.20 | 0.1 |
| Phosphorus content | NFT60-227 | >25 | <5 | <5 |
| Monoglyceride content (%) | ARKEMA | — | — | 1.31 |
| Diglyceride content (%) | ARKEMA | — | — | 0.75 |
| Triglyceride content (%) | ARKEMA | — | — | 0.0 |

TABLE 19
Phorbol ester distribution in a fractionation
with the conventional method 10-E27

| | | | | PE |
|---|---|---|---|---|
| | | PE | PE | distribution |
| | | content | mass | (in % of PEs |
| | Mass g | mg/g | mg | of the seed) |
| Seed used | 100 | 3.5 | 350 | — |
| Oil cake | 73.0 | 2.4 | 175.2 | 50.1 |
| Crude press oil | 19.5 | 11.5 | 214.5 | 61.3 |
| Semi-refined oil | 19.0 | 7.4 | 140.6 | 40.2 |
| Methyl ester | 18.6 | 3.1 | 57.7 | 16.5 |
| Crude glycerin | 2.3 | 0.8 | 1.8 | 0.5 |
| Total losses | — | — | 115.3 | 32.9 |

### Comments:

a large part (61.3%) of the phorbol esters is found in the press oil, but said esters degrade over the course of the semi-refining and transesterification steps;
the press oil cake has a very high PE content compared with the oil cake resulting from the method according to the invention, approximately 12 times higher. It is noted in passing that the balance with regard to the PEs in the oil cake and in the press oil is slightly in excess (+10%);
the semi-refining (neutralization+mucilage removal+drying) leads to a loss of ⅓ of the PEs of the crude oil;
the methanolysis leads to a loss of 60% of the PEs of the semi-refined oil;
the esters obtained are identical in terms of PEs to the esters resulting from the method according to the invention;
finally, approximately 33% of the phorbol esters were degraded in the conventional method, compared with 40% in the method according to the invention.
   Reactive Grinding with Ethanol

TABLE 20
Phorbol ester distribution in the products resulting from a reactive
grinding method carried out in the presence of ethanol (E10-E26)

| | | | | PE |
|---|---|---|---|---|
| | | PE | PE | distribution |
| | | content | mass | (in % of PEs |
| Product | Mass g | mg/g | mg | of the seed) |
| Seed used | 346.5 | 3.5 | 1230 | — |
| Dried flake (1) | 346.5 | 2.6 | 925 | 75.2 |
| Paste | 126.9 | NC* | — | — |
| Oil cake (2) | 233.9 | 1.0 | 234 | 19.0 |

(1) T = 100° C., 16 hours
(2) T = 100° C., 16 hours
*NC = analysis not carried out

### Comments:

the oil cake resulting from a method with ethanol proves to be 3 times more concentrated in terms of PEs than a methanolic oil cake, although its residual fat content is only 1.7 times higher. Consequently, the PEs appear to be less soluble in ethanol than in methanol;
as previously observed, and inexplicably, more extensive drying of the oil cake leads to an increase in the PE content in the oil cake.

In fact, the reactive grinding method according to the invention, in particular with methanol, and preferably in the presence of cosolvent and/or of a flake prepared by triple flattening of the seed, makes it possible to go directly from Jatropha seeds to fatty acid esters with a yield greater than 70%, or even greater than 80%, and simultaneously to obtain a detoxified oil cake containing a maximum of 0.03 mg/g of phorbol esters, said content being compatible with use of the oil cake in animal feed.

1. A method for treating seeds containing toxic components curcin, abrin, crotin and/or phorbol esters, said seeds having a degree of acidity of less than or equal to 3 mg KOH/g, said method comprising:
i) seed processing;
ii) bringing the processed seeds into contact with a light anhydrous alcohol and an alkaline catalyst under temperature and time conditions sufficient to allow extraction and the transesterification of vegetable oil, and producing a mixture comprising fatty acid esters and glycerol, and an oil cake,
wherein i) comprises seed flattening and drying operations.

2. The method as claimed in claim 1, in which i) also comprises preheating the seeds at a temperature of less than or equal to 100° C., the preheating operation being carried out before flattening.

3. The method as claimed in claim 1, in which the flattened-seed drying operation of i) is carried out rapidly after flattening, in less than one hour, at a temperature sufficient to reduce the moisture content of the seeds to 2% by weight or less.

4. The method as claimed in claim 1, in which ii) comprises a first reaction carried out at a temperature ranging from 30 to 75° C., for 15 to 60 minutes, followed by extraction with alcohol carried out in 3 to 9 stages and in a countercurrent direction.

5. The method as claimed in claim 1, in which the flattening operation is carried out by means of a mechanical roller flattener.

6. The method as claimed in claim 1, in which i) and ii) are carried out continuously.

7. The method as claimed in claim 1, in which the light alcohol is methanol.

8. The method as claimed in claim 1, in which the alkaline catalyst is sodium hydroxide.

9. The method as claimed in claim 1, in which the catalyst/alcohol/seeds weight ratio is included in the range 0.001 to 0.01/0.1 to 5/1.

10. The method as claimed in claim 1, in which, in ii), a cosolvent is also added, which cosolvent is hexane, heptane, benzene, bicyclohexyl, cyclohexane, decalin, decane, spirit, petroleum ether, kerosene, kerdane, diesel oil, paraffin oil, methylcyclohexane, naphtha (Texsolve V), skellite, tetradecane, Texsolve (B, C, H, S, S-2, S-66, S-LO, V), supercritical CO₂, propane or butane which are pressurized, natural solvents, ethers, ketones or mixtures of all these solvents.

11. The method as claimed in claim 1, in which the mixture comprising fatty acid esters and glycerol is subjected to a decanting which makes it possible to obtain an upper phase composed predominantly of fatty esters of a fatty acid and a lower phase composed predominantly of glycerin and of water.

12. The method as claimed in claim 11, in which said upper phase is subjected to a succession of chemical reactions and/or of separations/purifications producing biodiesel.

13. The method as claimed in claim 1, in which the Jatropha seeds are mixed with soybeans in a ratio of 1 to 10.

14. A mixture of fatty acid methyl esters which can be obtained by means of the method as claimed in claim 13, comprising from 15 to 40% by weight of oleic acid methyl esters.

15. (canceled)

16. The method as claimed in claim 1, in which the oil cake obtained is subjected to drying under temperature and time conditions sufficient to inactivate the curcin.

17. The method as claimed in claim 16, in which the drying of the oil cake is carried out for 4 h at a temperature of less than or equal to 200° C.

18. A detoxified jatropha oil cake which can be obtained by means of the method as claimed in claim 1, which has:
a degree of curcin detoxification of at least 90%, with respect to activity, when this degree is measured by means of a quantitative test;
a phorbol ester content of less than or equal to 0.3 mg/g.

19. An animal feed comprising the oil cake as claimed in claim 18.

20. The method according to claim 1, wherein the seeds are Jatropha seeds.

21. The method as claimed in claim 1, in which the flattened-seed drying operation of i) is carried out rapidly after flattening, in 5 to 10 minutes, at a temperature sufficient to reduce the moisture content of the seeds to 2% by weight or less.

22. The method according to claim 10, wherein the cosolvent is limonene, alpha or beta pinene, dimethyl ether, diethyl ether, acetone or mixtures thereof.
